(19) United States
(12) Patent Application Publication
(10) Pub. No.: US 2012/0045220 A1
(43) Pub. Date: Feb. 23, 2012

(54) MULTI CHANNEL ENCODER, DEMODULATOR, MODULATOR AND DIGITAL TRANSMISSION DEVICE FOR DIGITAL VIDEO INSERTION IN NETWORK EDGE APPLICATIONS

(76) Inventors: Sasa Veljkovic, Whitby (CA); John Joseph Lee, Whitby (CA)

(21) Appl. No.: 13/286,900

(22) Filed: Nov. 1, 2011

Related U.S. Application Data
(63) Continuation-in-part of application No. 12/406,781, filed on Mar. 18, 2009.

(51) Int. Cl. H04B 10/04; H04L 27/36

(52) U.S. Cl. 398/186; 375/298

(57) ABSTRACT

A multi-channel encoder, demodulator, modulator and transmission system for digital video insertion in network edge applications includes a circuit comprising slots for receiving a plurality of plug-in demodulator and encoder cards, a transmission stream multiplexer in communication with the slots, a QAM modulator in communication with the transmission stream modulator, a optical transmission section in communication with the QAM modulator, and a monitor and control system for monitoring and controlling the circuit. The system also includes a power supply for powering the circuit, and a lockable cabinet for enclosing the circuit, the plug-in demodulator and encoder cards, and the power supply, the lockable cabinet enclosing space for a cable modem connectable to the circuit.

### RELATED APPLICATIONS

This application is a continuation-in-part application of U.S. Ser. No. 12/406,781, filed Mar. 18, 2009, the contents of which are hereby incorporated by reference.

### BACKGROUND

1. Field of the Invention

The present invention is directed to a digital video encoding (e.g., MPEG-2 or MPEG-4), reception and demodulation, multiplexing and digital transmission (e.g., QAM modulation/transmission) and more specifically to a multiple-channel encoder and transmission device suitable for use in a location at the edge of a RF based or optical based broadband network. Depending on the terminology, the edge of the network can range from the last centralized point of a broadband service provider's architecture (e.g., Hub site for MSO) or even the to the subscriber premise itself.

2. Description of Related Art

Digital video insertion systems are known in the art. Such systems allow broadband operators (e.g., MSOs, Telcos, Satellite) to insert content (audio, video and data) that is locally generated at locations at the edge of the network in a digital format. Typically these locations are referred to as MDUs (Multi Dwelling Units) and/or commercial properties. Digital video insertion systems can also be used for closed circuit applications which have digital reception terminals (e.g., a digital TV) in them. In the case of applications for MSOs (CATV), the locally generated content is encoded, multiplexed and delivered into the specific location at the edge of the network (e.g., MDU) as a digital QAM (quadrature amplitude modulation) signal.

Two platforms tailored to the MSO market using standards-based technology are the EGT HEMi™ and the Radiant Communications QRF series. However, those systems are not designed in a manner that has been optimized for an MDU or other similar application.

The EGT HEMi™ is a rack mount PC based product and inherently is not suitable for an MDU environment from both an installation and environmentally hardened standpoint.

Because the platform is PC based and therefore the application cards (e.g., Encoders and demodulators) are PCI interface based, it is not easily scaled, since it requires the removal of the cover in order to install new application cards.

This product does not contain the complete RF management functionality (RF ports for input and output test points, RF tap ports for input signal to be directed to a demodulator, RF tap ports for input signal to be directed to a cable modem, RF ports for the coupling of the device's output and the incoming spectrum), nor the ability to house a channel deletion filter. The HEMi™ would require additional equipment to be installed in order to fully address the same issues as addressed by the present invention.

The HEMi™ is not provided in a wall mount cabinet style housing with a lockable front door and therefore is easily tampered with. Further, the lack of a cabinet-style housing does not provide the opportunity for a user to easily and securely co-locate a communications device (e.g., Cable modem) with the product so that it can easily be monitored and controlled from a remote location.

The HEMi™ does not provide field-removable power supply or cooling fans, making this difficult to service in the field in the event that any of these components fail.

The EGT HEMi™ is limited to a power supply that can accept power from the utility power only and does not provide a power supply that can be powered from an MSO's power supply:

While the EGT HEMi™ is known to provide an RF bypass switching functionality that is used in add/drop applications in order to allow the incoming RF signal to be passed based on the loss of power in the unit or loss of the HEMi's QAM output signal, it is unknown whether the HEMi also incorporates a QAM output switch that terminates the output until the product is fully booted and the QAM output is stabilized and is ready to be transmitted out of the product. Such output suppression capability would be desirable in order to avoid undesired signals being inserted into the network.

The Radiant QRF products are based on 1RU rack mounted chassis instances and are therefore not MDU environment suitable. The QRF product offering is scalable only through adding more of these chassis and connecting them electrically. This is cumbersome for an operator to install and manage and further increases the potential for failure of the applications, as more devices lead to a greater chance of a device failing.

The QRF does not contain the complete RF management functionality (RF ports for input and output test points, RF tap ports for input signal to be directed to a demodulator, RF tap ports for input signal to be directed to a cable modem, RF ports for the coupling of the device's output and the incoming spectrum), nor the ability to house a channel deletion filter. The QRF requires additional equipment to be installed in order to fully address the intended application.

The QRF series is not provided in a wall mount cabinet style housing with a lockable front door and therefore is easily tampered with. Further, the lack of a cabinet-style housing does not provide the opportunity for a user to easily and securely co-locate a communications device (e.g., Cable modem) with the product so that it can easily be monitored and controlled from a remote location.

The QRF does not provide a field-removable power supply or cooling fans, making this difficult to service in the field in the event that any of these components fail.

The QRF is limited to a power supply that can accept power from the utility power only and does not provide a power supply that can be powered from an MSO's power supply.

The QRF does not provide an integrated RF bypass switching functionality that is used in add/drop applications in order to allow the incoming RF signal to be passed based on the loss of power in the unit or loss of the QRF's QAM output signal. Further, the QRF does not incorporate a QAM output switch that terminates the output until the product is fully booted and the QAM output is stabilized and is ready to be transmitted out of the product. Such output suppression capability is desirable in order to avoid undesired signals being inserted into the network.

### SUMMARY OF THE INVENTION

It is therefore an object of the invention to overcome the above-noted disadvantages of the prior art.

It is another object of the invention, in at least some embodiments, to provide a digital video insertion system (DVIS) that is suitable for use in network edge locations, where network edge is defined as in the present specification.

It is still another object of the invention, in at least some embodiments, to provide a digital video insertion system that is easily scalable. This scalability is achieved through plug-in application cards located on an interface that is easily accessed by the user.

It is still another object of the invention, in at least some embodiments, to provide a DVIS having integrated RF management functionality (RF ports for input and output test points, RF tap ports for input signal to be directed to a demodulator, RF tap ports for input signal to be directed to a cable modem, RF ports for the coupling of the device's output and the incoming spectrum), the ability to house a channel deletion filter, both of which allow for an efficient and craft friendly method of installing this equipment at a location for its intended application.

It is still another object of the invention, in at least some embodiments, to provide a DVIS in a format that is optimized for MDU style environments. This involves the product to consist of a wall mount cabinet style housing with a lockable front door.

It is still another object of the invention, in at least some embodiments, to provide a DVIS in a format that is optimized for MDU-style environments. Such embodiments permit a communications device (e.g., a cable modem) for remote access to the product to be placed within the lockable cabinet.

It is still another object of the invention, in at least some embodiments, to provide a DVIS in a format that accommodates both a removable/replaceable power supply and removable/replaceable fans.

It is still another object of the invention, in at least some embodiments, to provide a DVIS in a format that can be powered from normal utility power or with MSO network power.

It is still another object of the invention, in at least some embodiments, to provide a DVIS that provides both input RF bypass and output termination switching capability.

It is still another object of the invention, in at least some embodiments, to provide a multi-channel encoder, demodulator, modulator and transmission system for digital video insertion in network edge applications that includes a circuit comprising slots for receiving a plurality of plug-in demodulator and encoder cards, a transmission stream multiplexer in communication with the slots, a QAM modulator in communication with the transmission stream modulator, an optical transmitter section in communication with the QAM modulator, and a monitor and control system for monitoring and controlling the circuit. The system also includes a power supply for powering the circuit, and a lockable cabinet for enclosing the circuit, the plug-in demodulator and encoder cards, and the power supply, the lockable cabinet enclosing space for a cable modem connectable to the circuit.

It is still another object of the'invention, in at least some embodiments, to provide a multichannel digital video insertion system for providing a multiplexed output digital video signal that includes at least one video encoder module that includes an input connector for receiving a video signal, an encoder circuit for converting the video signal to a QAM signal, and an output connector for communicating the QAM signal. The system also includes an optical transmission section with an input configured to receive the QAM signal and an output configured to transmit the QAM signal over an optical cable. The system includes a cabinet having an area for receiving the video encoder module and the optical transmission section that is accessible from outside of the cabinet such that the video encoder module and the optical transmission section are insertable and removable from outside of the cabinet.

To achieve the above and other objects, the present invention is directed to a DVIS designed to be installed in an MDU/commercial property environment, where a traditional rack mount product would not be easily installed. In MDU environments, a wall-mounted cabinet which integrates all the necessary technology for any of its intended applications is far more efficient for an operator. Further, since it is a cabinet that can be opened in order to access the front panel to remove and/or add plug-in application cards, it is far more efficient for an operator to scale its functionality.

The present invention is further directed to a DVIS having a channel deletion filter. Such a channel deletion filter can be used to produce an empty QAM slot into which locally produced programming can be inserted.

The present invention is still further directed to a DVIS incorporating both of the above aspects.

Embodiments of the present invention can be utilized at edge locations, which include the last centralized point of the network, where narrowcasting of a digital transmission to a specific subset of the locations served by that centralized point can be facilitated or at edge locations such as multiple-dwelling units (MDU, e.g., an apartment building or retirement home), commercial properties or even in areas where closed circuit video transmissions occur.

The preferred embodiment is primarily standards based in terms of the functional blocks it is built upon, e.g., input encoder cards would utilize MPEG2 or MPEG 4 encoding, which is a defined standard known to the general public. However, the manner in which the present invention incorporates such standards is deemed to be novel.

At least some embodiments have been designed for use by an MSO-CATV operator. However, the base design of the invention can easily be extrapolated to satisfy a number of other applications in other markets such as Satellite (Dish) and telephone companies (like Verizon).

The product is designed around the concept of taking baseband A/V and/or digital video content in, manipulation of that digital video content, and digital video content out. As known in the art, digital video incorporates audio, video and data oriented content. The product can be broken up into three main functional blocks: Input(s), Output(s), and Multiplexer.

Inputs can come from a variety of sources, including A/V baseband content as well as via digital video transmission standards (QAM, QPSK, COFDM, ASI, and IP). In order to receive and demodulate these input signals, there are a number of input specific cards that can be plugged into the product. They include:

a) Encoder Cards: multi-channel, capable of encoding baseband video into a number of encoded standards such as MPEG 2, MPEG 4 SD or HD

b) Tuner/demodulator cards: QAM, QPSK, COFDM or IP (10/100BaseT, GigE), ASI

c) optical receiver card—can receive QAM, QPSK, COFDM if it is modulated onto an optical carrier

d) IP Input cards—10/100baseT, GigE (wired, wireless or optical)

e) ASI input cards (wired or optical)

Outputs can include one or more of the following. The unit is currently designed with a primary output that is a part of the base unit (not a plug-in card); this output can include QAM, multiQAM, QPSK, COFDM etc., IP, ASI. Further, card based outputs can also be provided and include:

b) ASI output (wired to optical)

c) IP output—10/100baseT, GigE (wired, wireless or optical)

d) optical transmitter—can transmit QAM, QPSK, COFDM etc.

The output signal on this device can be monitored by the product, on in the event of its failure, an RF bypass switch will flip in order to pass the original incoming signal that the product is receiving.

The multiplexer performs digital video content manipulation. It receives content from the input cards and manipulates the content in a manner that is desired (user defined) for the intended outputs of the product. Specially, the multiplexer performs the creation of output MPEG2 (or another suitable standard) transport streams (MPTS or SPTS) from input MPEG2 transport streams (SPTS or MPTS), where the input transport streams are a result of encoded A/V baseband signals; or transport streams that are received through any of the inputs disclosed above or any other suitable inputs. The output MPEG2 transport streams are transitioned out of the product through the output interfaces disclosed above or any other suitable outputs. The multiplexer performs the following functions:
receives and processes MPEG 2 TSs from a number of inputs
allows the transport streams to be analyzed so that information on each of the input transport streams (including, but not limited to MPEG parameters, bit rate) can be provided
allows the transport streams to be modified (MPEG parameters including but not limited to PIDs or MPEG program numbers)
allows specific programs in the input transport streams to be “dropped” and replaced with (add/drop feature) programs from another input transport stream
ensures that the add/drop functionality is performed in a manner such that the new transport stream created by performing this function is formatted in a manner suitable for the output it is intended
QBA and AF analysis and correction required for use with legacy set top boxes

All of this functionality can be performed while maintaining MPEG 2 TS specifications so that the video is not compromised (e.g., PCR insertion).

Another aspect of at least some embodiments of the invention is packaging. For many of the applications that this product will service, the product will be positioned at the edge of the network in a location such as an MDU (multi-dwelling unit) or commercial property. Such locations do not have head-end or central office style climate controlled facilities and therefore, standard rack mount equipment can be problematic to install and manage. The packaging is designed in a manner to accommodate airflow for appropriate cooling of the product; strategic positioning of fans and slots in the package takes into account the practical installation of the product. The packaging provides:
front access so that input and output cards are easily slid in and out of the chassis
wall mount, lockable cabinet 9 130855.00134135928756v.1
integrated channel deletion filter
front access, plug-in functional cards
removable power supply
integrated RF management to accommodate digital video insertion in MSO (CATV) applications
IP based management and control allows for remote access to the unit using modem base technologies
integrated RF bypass switch: used in applications for deleted channel or add/drop

The management interface is IP based and therefore can accommodate remote connection (e.g., through a cable modem or DSL modem). The management interface allows the user to gain access to the product in order to analyze the input and output characteristics of the program streams as well as to control a variety of the operating functions. This includes:

a) encoding parameters and characteristics

b) output parameters and characteristics

c) input parameters and characteristics

d) multiplexing parameters and characteristics

e) device management connectivity (e.g., DHCP, SNMP etc.)

Due to the nature of this product, there area variety of applications for it in a number of broadband service provider markets including Cable TV, Telco and Satellite. In each specific case, the primary functions performed are the same, and only the input and output interface specifications change. For example, cable television uses QAM transmission, while satellite television uses QPSK.

At least one embodiment allows a broadband operator to insert locally generated content (e.g., door security camera feed to be inserted in digital format) into the spectrum that the broadband provider is supplying into the local area. There are a number of methodologies that can be deployed to implement this application:

Blank Channel:

The broadband service provider leaves space (a “blank”) within their delivered signal spectrum so that content can be inserted in an appropriate frame. An example of this with respect to Cable TV would be an MSO leaving a 6 MHz wide slot open in the spectrum of signals leaving the headend, so that the QAM output from the product can be inserted into that slot at the local area (e.g., MDU) and subsequently passed into the local area.

Deleted Channel and/or Add Drop:

This method involves the broadband operator filtering or dropping content out of their spectrum locally, so that new locally generated content can be inserted and delivered in the local area.

Examples of this are:

a) A CATV operator deletes an entire QAM channel locally and inserts a new QAM from the product's output in the deleted QAM channel's place.

b) A CATV operator receives a QAM channel, demodulates it and then drops some of the programs that are delivered in that QAM and combines locally generated programs with the programs associated with the incoming QAM that were not dropped, and then outputs this on a new QAM signal into the local serving area.

The integrated RF bypass switch monitors the output signal of the product for loss of output signal and in the event that the output signal is lost, switches a bypass switch so that the incoming QAM channel in a) bypasses the channel deletion filter and can be passed into the MDU.

Digital Content Grooming/Filtering is accomplished as follows. At a local area, a number of input signals are delivered to the product's inputs, received and demodulated. Once demodulated the product allows the broadband service provider to select the content that is desirable to pass to the output(s) of the product. In essence, the product in this case acts as a program stream filter, filtering out specific programs within the digital content stream.

The Digital Content Backhaul application allows a broadband service provider to encode content generated in a local area and deliver it from a local area back through their network to their headend or central office. An example of this is a CATV provider who wants to backhaul content generated at city hall so that it can be turned around at their headend and delivered to the entire headend serving area. In this case, the product would allow the CATV operator to encode the content generated at city hall and then transmit it upstream through their HFC network as a QAM signal to the headend. The signal can be appropriately processed at the headend and then delivered to the entire area serviced by the headend. The means with which the content to be backhauled is delivered is network dependent, but basically any transmission specification can be accommodated (QAM, QPSK, COFDM, ASI, and IP).

### BRIEF DESCRIPTION OF THE DRAWINGS

A preferred embodiment and variations thereon will be disclosed in detail with reference to the drawings, in which:

FIGS. 1A and 1B are exterior views of a system according to the preferred embodiment;

FIG. 2 is a view of a plug-in card usable in the system of FIGS. 1A and 1B;

FIG. 3 is a functional schematic diagram of the system of FIGS. 1A and 1B;

FIGS. 4A-4C show three types of digital video insertion methodologies specific to MSO style applications using RF QAM insertion techniques;

FIGS. 5A and 5B show a head end or hub site (last centralized point in the network) unit usable with the system of FIGS. 1A and 1B;

FIG. 6 is a functional schematic diagram showing a digital insertion methodology where content is locally encoded, multiplexed and transported back to a central serving area (in his case a head end or hub site) so that it can be turned around at the central serving area and narrowcast to a specific group of subscribers (or nodes);

FIG. 7 illustrates a digital video insertion system that includes an optical transmission section;

FIG. 8 illustrates an exemplary optical transmission section that may correspond to the optical transmission section of FIG. 7; and

FIG. 9 illustrates an exemplary use case for the digital video insertion system of FIG. 7.

### DETAILED DESCRIPTION OF THE PREFERRED EMBODIMENT

A preferred embodiment of the present invention will be set forth in detail with reference to the drawings, in which like reference numerals refer to like elements throughout.

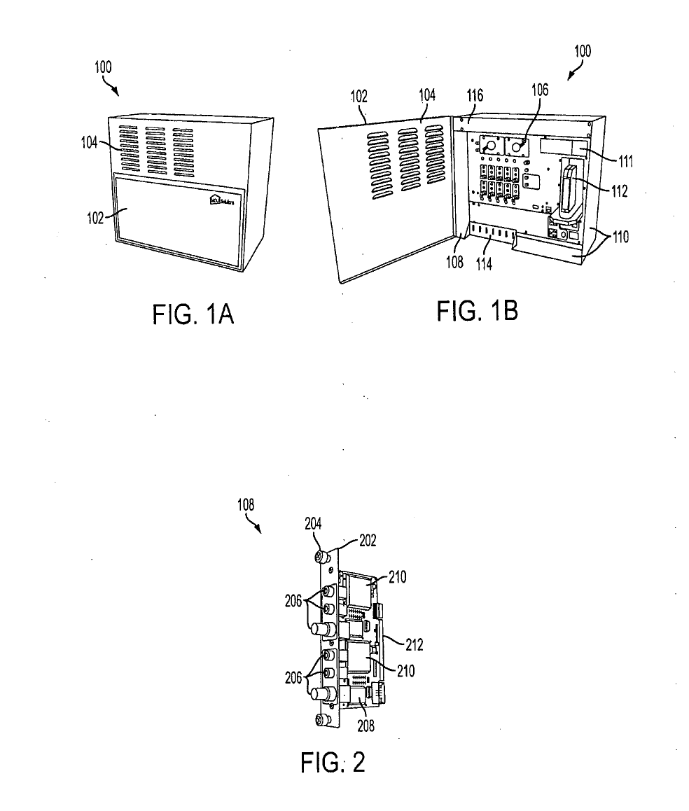

FIG. 1A shows a perspective view of the system 100 with the front door 102 closed. The front door 102 is front-mounted to allow easy access in an MDU installation and has louvers 104 to allow air circulation for cooling. The front door 102 is lockable to provide a lockable cabinet with ability to house a communications device such as a cable modem.

FIG. 1B shows the system of FIG. 1A with the door 102 open, so that components which are concealed with the door 102 closed can be seen. The system includes removable cooling fans 106 above encoder or demodulator/units where 108 is illustrative of their appearance and form factor. The encoder or demodulator units 106 are hot-swappable and accessible from the front of the unit, so that a person standing in front of the system can easily insert and remove them. The system also includes an Ethernet or other suitable interface 110, a removable power supply 111 which can draw power from the power utility or the network, and an LCD front panel 112 to allow the person to monitor the operation of the system. Also included are RF connection ports 114 associated with integrated RF management and including RF IN, RF OUT, TO DEMOD, TO CABLEMODEM, MODULATOR OUTPUT, TO COMBINING, as well as a location for an integrated deletion filter 116.

The system 100 allows cost-effective insertion of locally generated MDU content (e.g., security camera feeds or localized advertising) as MPEG-2/QAM. It can be used for spectrum reclamation or MDU's provisioned with digital-only set-top boxes. Up to four A/V programs can be multiplexed onto a QAM channel and delivered to the MDU.

FIG. 2 shows one of the encoder units 108. The form factor is representative of a multi-channel encoder or a demodulator. The unit has a face plate 202 with mounting screws 204 (or another suitable attachment) and input and output ports 206. Behind the face plate 202 is a printed circuit board 208 with circuitry 210, which will be explained below. On the edge of the printed circuit board 208 remote from the face plate 202 is an edge connector 212 for insertion into an edge connection slot in a mainboard (not seen in FIG. 1A, 1B, or 2).

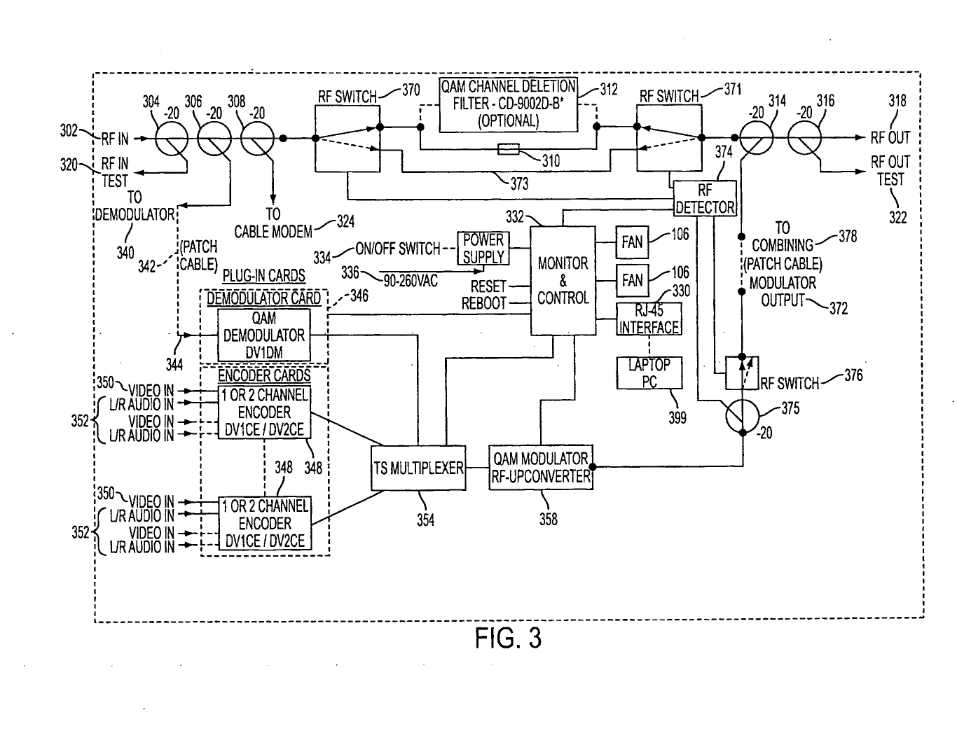

FIG. 3 is a functional schematic diagram showing the system 100. An RF IN 302 is connected through RF directional couplers 304, 306, 308, which are then connected to an RF switch connected to an “F” joint (or barrel) 310 and optionally to a QAM channel deletion filter 312. The “F” joint (or optional QAM channel deletion filter) is connected to RF switch 370 and subsequently RF direction couplers 314, 316 and thence to an RF OUT 318. The tap leg of RF directional coupler 304 is intended to tap off a portion of the input signal energy and provide this to an RF input test point 320, labeled RF IN TEST. The tap leg of RF directional coupler 306 is intended to tap off a portion of the input signal energy and provide this to an RF output port 340 (TO DEMODULATOR) that can be used to feed the signal to a demodulator card in the product 320, labeled RF IN TEST. The tap port of 308 can be connected to a CM (cable modem) OUT 324 to an optional cable modem (not shown in figure). The channel deletion filter 312 deletes an entire 6 MHz digital QAM channel and allows a new channel to be reinserted. RF directional coupler 314 is intended to couple energy through a port connection 378 (TO COMBINING) and allow for the insertion of an output signal from port 372 (MODULATOR OUTPUT) which is generated from the internal QAM modulator 358. RF directional coupler 316 is intended to tap off a portion of the unit's RF output signal and provide an RF output test point 322 (RF OUT TEST).

RF Bypass switches 370 and 371 direct RF signal flow through the F joint 310 or optional channel deletion filter 312 path under normal operation. However, in the event that the RF detector 374 detects that measures a sample of the output energy from the RF directional coupler 375 from the output of the QAM modulator 358, has dropped below a defined threshold level, the switches 370 and 371 will route the RF signal through the RF bypass path 373. The switches also route the RF signal through the bypass path 373 in the event that power to the entire product is not longer present.

RF Switch 376 terminates the output of the QAM modulator 358 in the event where the QAM output has dropped below a specific threshold or during the boot up of the product where in some instances the QAM modulator is not stable and can provide an undesired output.

Either the optional cable modem (not shown) or a laptop computer 399 external to the system 100 can be connected via an RJ-45 or other suitable interface 330 to a monitor and control system 332, which is powered from a conventional electrical outlet 334 or an 90-260 VAC power source 336 and a power supply 338. The monitor and control system controls the fans 106. The cable modem, laptop computer, or other device can be used to access the monitor and control system 332 for monitoring and control, as described above.

The plug-in encoder or demodulator units 348 or 346 respectively, also connect to the monitor and control system 332. The port, labeled TO DEMODULATOR 340 is connected via a patch cable 342 to the input port 344 of the demodulator card 346.

Each encoder unit 348 can have a single- or two-channel encoder system, with each channel each receiving input signals from a video source VIDEO IN 350 and an audio source L/R AUDIO IN 352.

The system can accommodate a plurality of encoder 348 or demodulator 346 units. The plurality of encoder units 346 and demodulator units 348 supply their outputs to a TS (transport stream) multiplexer 354.

Finally, the monitor and control system 332 can be reset through a reset signal 360.

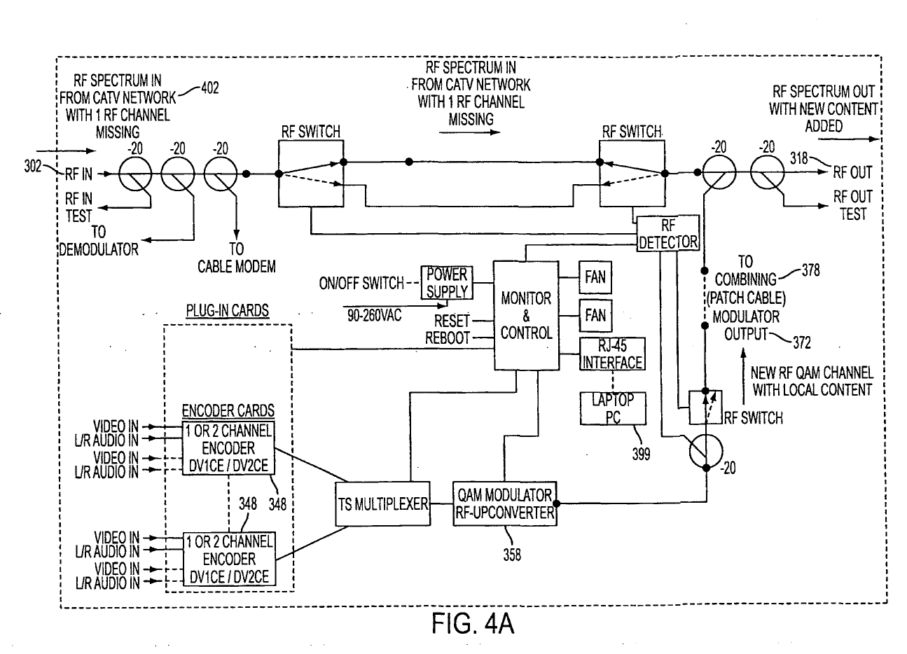

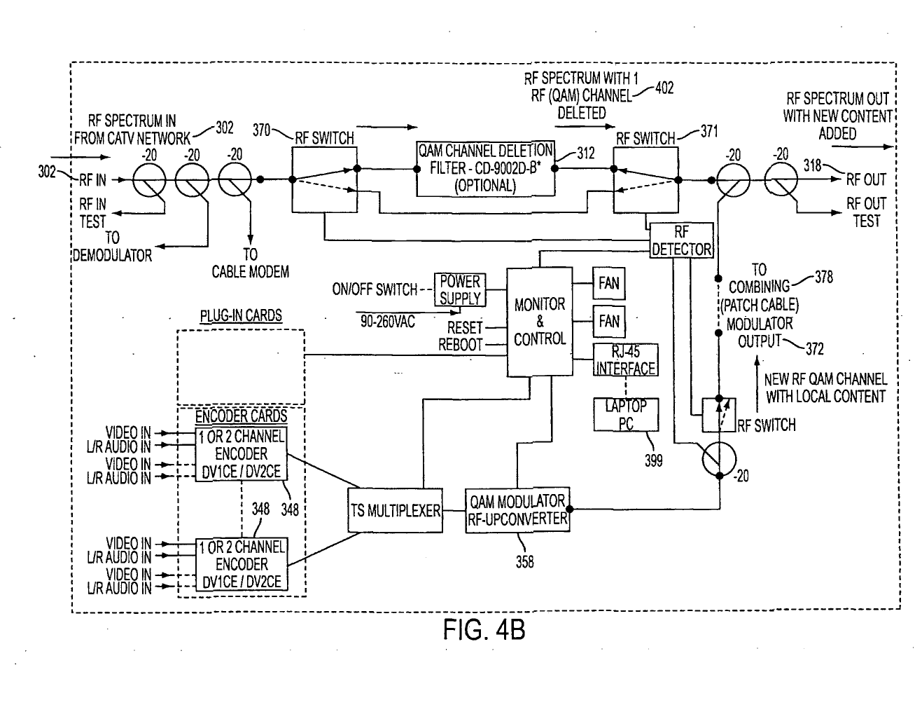

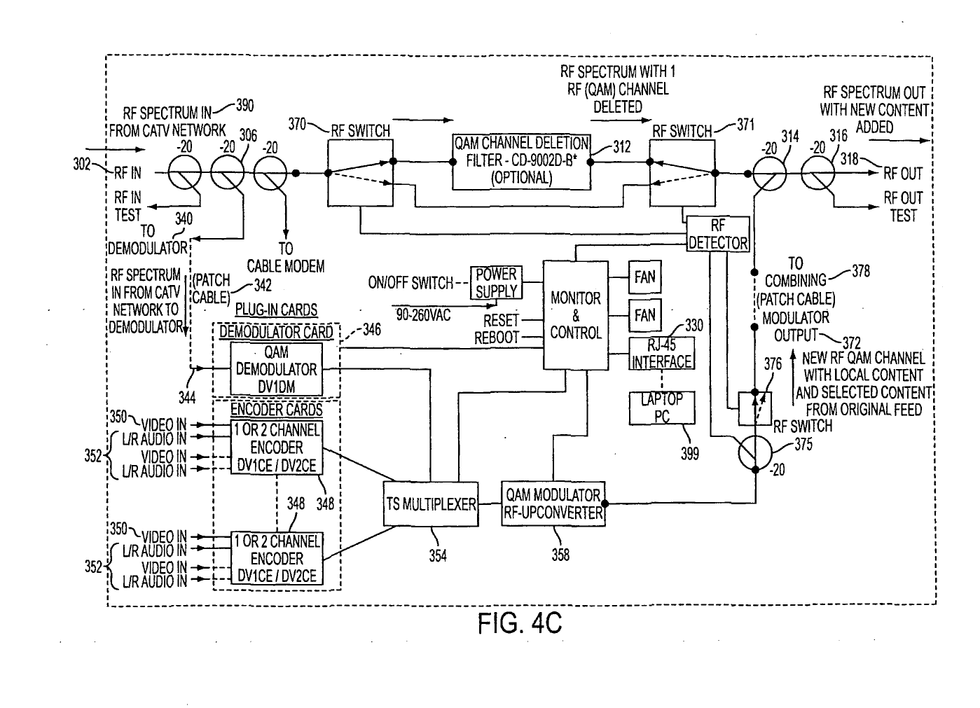

As described above, digital insertion is an important aspect of the present invention. Three types of digital insertion will now be described with reference to FIGS. 4A-4C.

FIG. 4A shows “blank QAM” digital insertion, so called because the signal received at RF IN 302 includes an empty QAM slot (or missing RF channel) 402. In that case, the QAM modulator and RF up converter 358 simply fills the empty QAM slot with the content that has been encoded by the encoding units 348 and transmits thorough the port MODULATOR OUTPUT 372. The MODULATOR OUTPUT 372 can be connected to the TO COMBINING PORT 378 so that the QAM signal can be coupled to the RF OUT port 318.

FIG. 4B shows “locally deleted QAM” digital insertion. A QAM channel deletion filter 312 is connected between the switches 370 and 371 respectively in order to delete an empty RF (QAM) slot 402. The QAM modulator and RF upconverter 358 then fills the empty QAM slot with the content that has been encoded by the encoding units 348 and transmits thorough the port MODULATOR OUTPUT 372. 372 can be connected to the TO COMBINING PORT 378 so that the QAM signal can be coupled to the RF OUT port 318

FIG. 4C shows “underutilized QAM (add/drop)” digital insertion. The input signal that is injected on RF IN 302 is tapped off by the RF directional coupler 306 and passed through port 340 and connected via a patch cable 342 to the RF input 344 on the demodulator unit 346. The content that is demodulated is passed to the TS multiplexer. The input signal also passes through a channel deletion filter connected to switch 370 and 371 respectively so that the incoming QAM signal can be deleted and/or isolated from the output section of the product. Local Audio Video content is injected on the encoder card(s) 348 through the video input(s) 350 and audio input(s) 352, where is then encoded and sent to the TS multiplexer 354. By utilizing a lap top 399 and the RJ 45 interface a user is able to select the content from the input QAM channel that is a part if the input spectrum 390 applied to the input of the device (RF IN) 302 that will be dropped and replaced with the content that has been encoded by 348. Once this is configured by the user the TS Multiplexer 354 performs the necessary functions to achieve the desired configuration and then transports the TS output to the QAM Modulator 358, which in turn transmits this signal through 375, 372, 378, 314, 316 and ultimately 318.

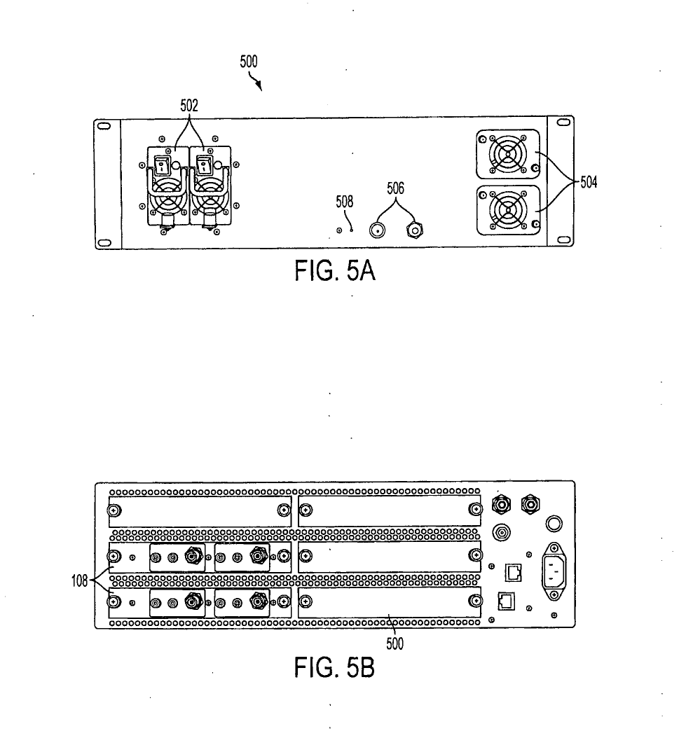

FIG. 5A is a front view showing a rack-mountable head end unit 500 usable with the system 100 of the preferred embodiment or any other system according to the present invention. The front panel has redundant replaceable power supplies 502, replaceable cooling fans 504, ports 506 and an LED display 508. The back, shown in FIG. 5B, accommodates encoder or demodulator units whose form factor is illustrated in 108 like those already explained. The encoder or demodulator 108 is easily removable and replaceable without having to remove the system 500 from the rack.

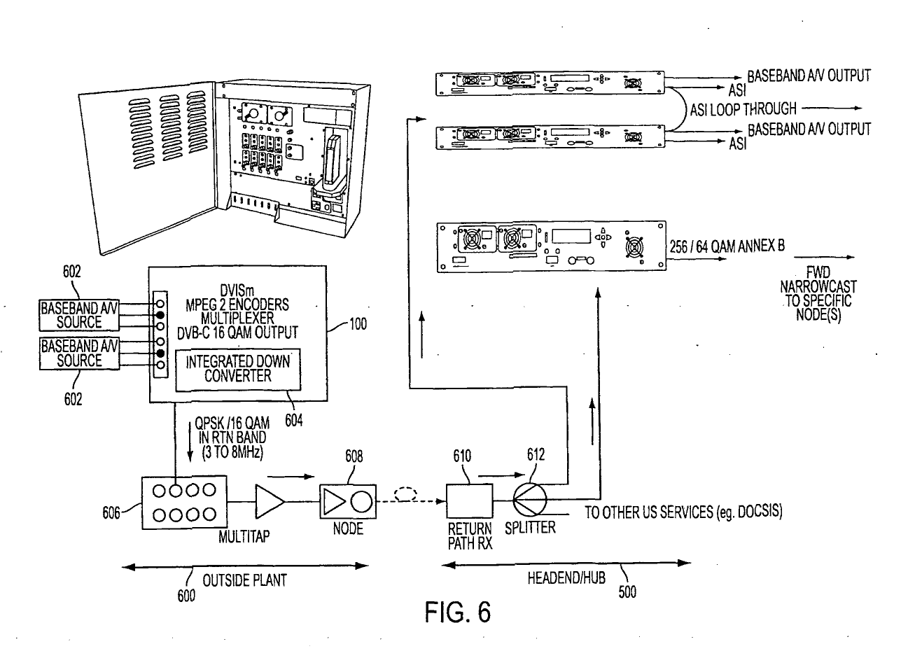

FIG. 6 is a functional schematic diagram showing a digital insertion methodology where content is locally encoded in a DVIS 100 at a location 600, multiplexed and transported back to a central serving area (in his case a head end 500) so that it can be turned around at the central serving area and narrowcast to a specific group of subscribers (or nodes). Content from baseband AV sources 602 is supplied to a DVIS 100, where it is encoded as described above and down converted in an integrated down converter 604 to produce a QPSK/16 QAM output in the RTN band (3-8 MHz). That output is supplied to a multitap 606, a node 608, a return path receiver 610 and a splitter 612 to the head end 500, where it is converted into appropriate formats.

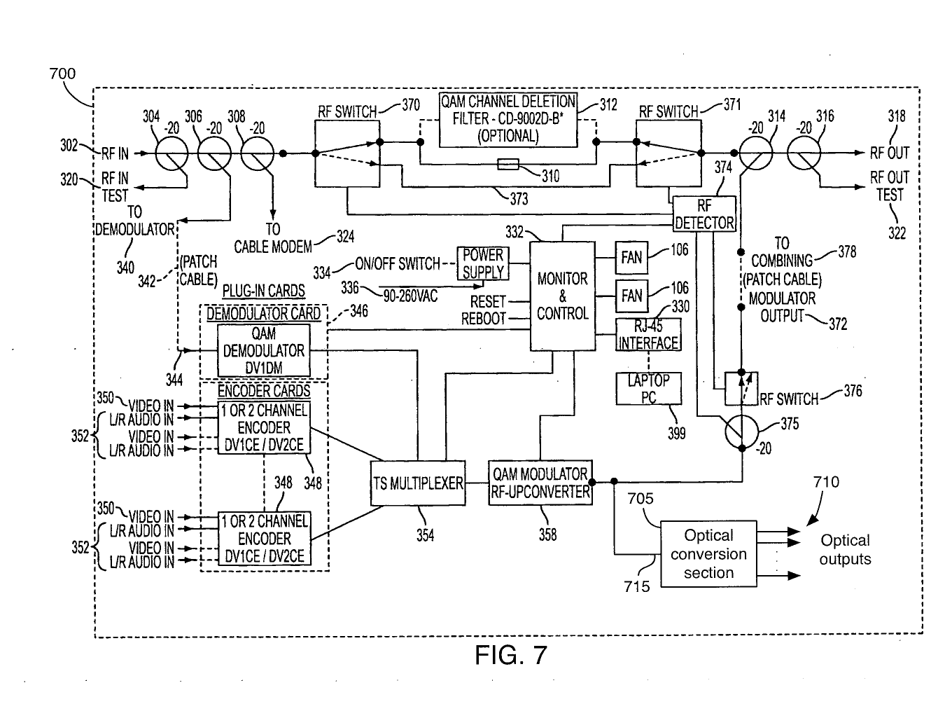

FIG. 7 illustrates yet another embodiment of a digital video insertion system 700. The system 700 may include the various components described above with reference to FIG. 3. In addition, the system 700 includes an optical transmission section 705. However, in some implementations one or more of the features described in FIG. 3 may not be included. For example, the RF output section may not be required in some implementations.

The optical transmission section 705 includes an input 715 configured to receive a QAM signal and one or more outputs 710 configured to transmit the signal over an optical fiber. The optical transmission section 705 facilitates the insertion of video signals into a passive optical network (PON) that utilizes 1550 nm overlay service for transmitting video content. 1550 nm overlay is a term used to describe video content in RF format that is modulated onto an optical wavelength that is nominally 1550 nm and then transmitted into across optical network that could also be carrying PON signals.

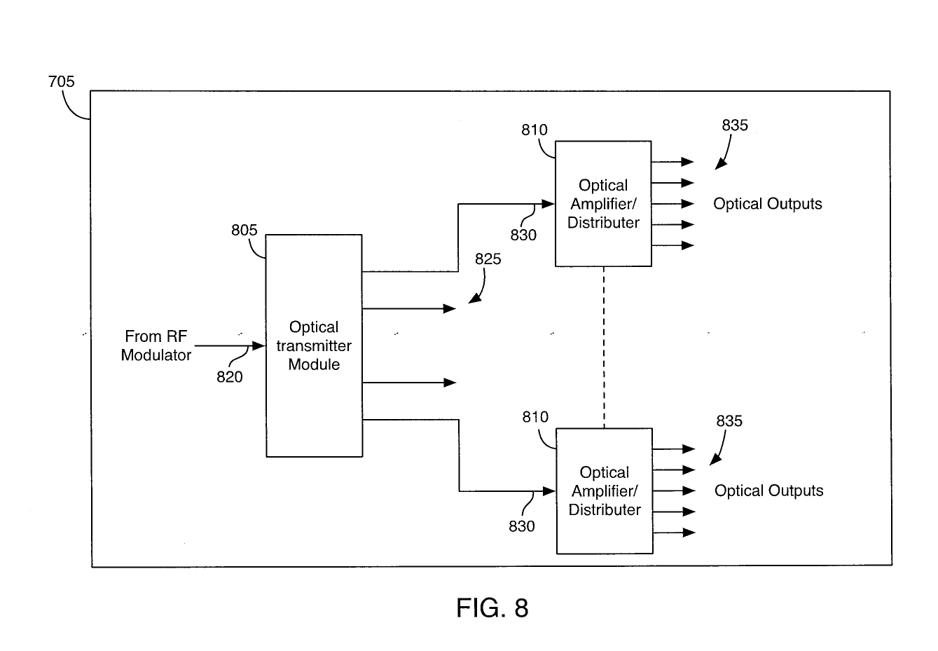

FIG. 8 illustrates one embodiment of an optical transmission section 705. The optical transmission section 705 includes an optical transmitter module 805 and a pair of optical amplifiers 810. The optical transmitter module 805 and the optical amplifiers 810 may each be housed within separate modules or cards similar to the unit 108 described above and illustrated in FIG. 2. The cards are configured to be inserted into openings in the front of the digital video insertion system 700 (i.e., the cabinet) into which a circuit is housed and to mate with respective connectors of the circuit. The circuit provides power, data and other signals to the respective modules, as is the case with other units 108 that may be inserted within the cabinet, as described above. The optical amplifiers 810 are coupled to optical outputs 825 of the optical transmitter module 805. While two optical amplifiers 810 are illustrated, it is understood that the number of optical amplifiers 810 coupled to the optical transmitter module 805 may be different.

The front faces of the optical transmitter module 805 and optical amplifiers 810 may include various connectors, controls, LEDs, etc., that facilitate user control of the optical transmitter module 805 and optical amplifiers 810. The front faces are accessible when the cabinet is unlocked.

The optical transmitter module 805 may include an input section 820 for receiving an RF signal and optical outputs 825 that output an optical signal that carries the RF signal. The input section 820 may include one or more connectors for coupling RF signals, such as F-type, BNC, or different types of shielded connectors. The connectors may be positioned on the front face of the optical transmitter module 805 to facilitate quick patching-in of a given RF signal by a user. However, RF signals may be input to the optical transmitter module 805 through other means. For example, the RF signals may be input via the circuit in the cabinet into which the optical transmitter module 805 is coupled. For example, RF signals may be routed via a backplane to the optical transmitter module 805.

In one implementation, the RF signal is a QAM modulated signal that is generated by the QAM modulator 358, described above. The optical signal may correspond to a radio frequency over glass (RFoG) signal that is communicated at around a 1500 nm wavelength. The wavelength of the optical signal may be user specified. For example, the wavelength may be specified to be one of ITU channels 22-46, as defined by G.652 through G.655 standards documents, although other ITU channels may be specified in alternative embodiments.

The optical transmitter module 805 includes circuitry for modulating the RF signal received at the input section 820 onto optical the signal communicated from the optical outputs 825. While four optical outputs 825 are illustrated, it is understood that the number of optical outputs 825 may be different to accommodate coupling of the optical transmitter module 805 with a corresponding number of optical distributers 810.

The optical amplifier 810 may include an input section 830 for receiving an optical signal communicated from the optical transmitter module 805, and one or more optical outputs 835 configured to distribute an optical signal to a corresponding number of optical paths. The optical amplifier 810 may include a optical gain stage and an optical splitter.

The gain stage may correspond to an Erbium-doped fiber amplifier (EDFA) or an Erbium-Ytterbium doped fiber amplifier EYDFA. Such an amplifier utilizes a so-called pump laser to introduce energy into a doped fiber cable. The energy is subsequently transferred to a signal being communicated through the fiber, which increases the amplitude of the communicated signal. In some implementations, when gain is not required, the pump laser may be disabled. For example, gain may not be required for shorter optical paths (i.e., relatively short optical cables coupled to the optical outputs 835). Switches may be provided on the front face of the optical distributer 810 to allow a user to enable or disable this function. In addition or alternatively, the function may be enabled/disabled remotely via a network (e.g., the Internet). In yet other implementations, the gain provided may be adjustable via a control on the front face of the optical amplifier or adjusted remotely via a network. For example, the gain may be adjusted to produce an output signal with an amplitude of between 13 to 19 dBm.

After amplification, the amplified optical signal may be split via an optical splitter. For example, the optical signal may be split into four optical paths and output over a corresponding number of optical outputs 835 of the optical distributer 810. The optical outputs 835 may be positioned on the front face of the optical amplifier 810 to facilitate easy access to the outputs 810 when the cabinet is unlocked. Fiber cables that are part of a PON may be coupled to the optical outputs 835.

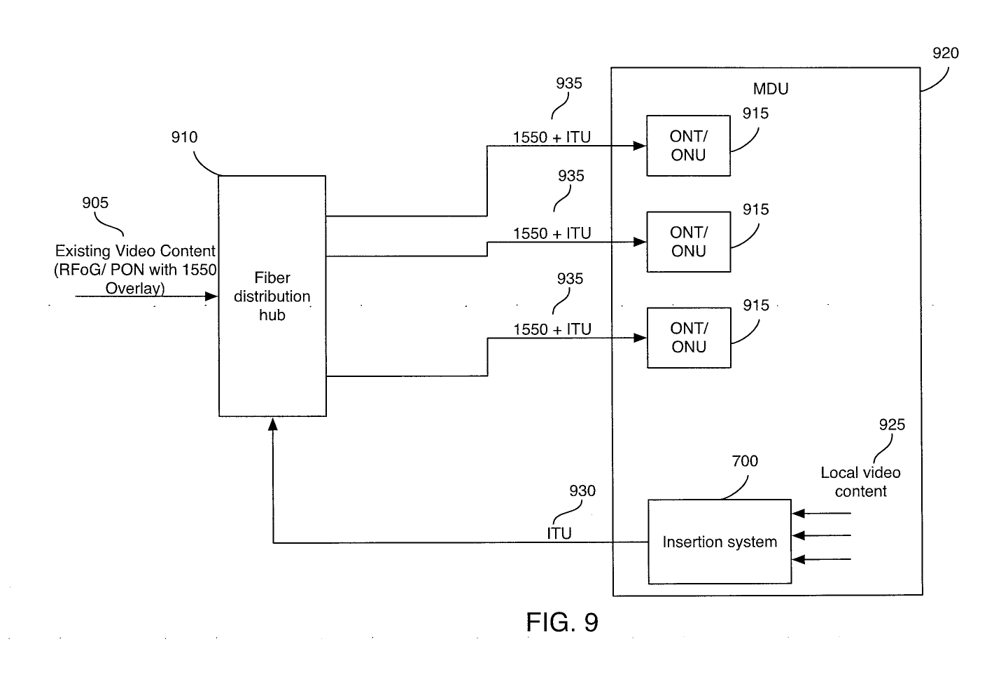

FIG. 9 illustrates an exemplary use case for the digital video insertion system 700. Existing video content 905 may enter a fiber distribution hub 910 via RFoG over a 1550 nm overlay service of a PON. The fiber distribution hub 910 is configured to split the optical signal of the PON into a number of paths. The divided signals are terminated at, for example, optical network terminals 915 in a multi-dwelling unit (MDU) 920, such as an apartment building.

Local video content 925, such as security camera feeds, is input to the video insertion system 700, which may also be positioned within the MDU 920. The video insertion system 700 converts the local video content 925 into on RF/QAM signal which in turn is modulated onto an optical signal at a user selectable wavelength, hereinafter referred to as the ITU channel 930). The wavelength selected is chosen so that it does not interfere directly with the wavelength of the “1550 nm video overlay” wavelength (905) that is already being transmitted within the optical network.

The fiber distribution hub 910 combines the ITU channel 930 with the existing video content 905 and outputs the combination (denoted 1550+ITU) 935 to the ONTs 915. The ONTs 915 may be coupled to equipment that converts the optical signals into an NTSC and/or PAL signal suitable for a television. A viewer is then able to switch to a channel associated with the ITU channel 930 to view, for example, a security feed in an apartment building.

While a preferred embodiment and variations thereon have been disclosed in detail above, those skilled in the art who have reviewed the present disclosure will readily appreciate that other embodiments can be realized within the scope of the invention. For example, other video encoding standards can be implemented in addition to, or instead of, those specified. Therefore, the present invention should be construed as limited only by the appended claims.

We claim:

1. A multi-channel encoder, demodulator, modulator and transmission system for digital video insertion in network edge applications, the system comprising:
a circuit comprising slots for receiving a plurality of plug-in demodulator and encoder cards, a transmission stream multiplexer in communication with the slots, a QAM modulator in communication with the transmission stream modulator, an optical transmission section in communication with the QAM modulator, and a monitor and control system for monitoring and controlling the circuit;
a power supply for powering the circuit; and
a lockable cabinet for enclosing the circuit, the plug-in demodulator and encoder cards, and the power supply, the lockable cabinet enclosing space for a cable modem connectable to the circuit.

2. The system of claim 1, wherein the optical transmission section comprises an optical transmitter configured to modulate a QAM signal output from the QAM modulator onto an optical signal and to communicate the optical signal over an optical fiber.

3. The system of claim 2, wherein the optical transmission section comprises at least one optical amplifier circuit that includes a plurality of optical outputs, wherein the at least one optical amplifier circuit is configured to distribute the optical signal from the optical transmitter to the plurality of optical outputs.

4. The system of claim 2, wherein an output signal of the optical amplifier is being modulated by an RF/QAM signal and is configured to be inserted into a passive optical network (PON) that has a 1550 nm video overlay service associated with it.

5. The system of claim 4, wherein the output signal of the optical transmission section is transmitted at an insertion wavelength that does not interfere with existing 1550 nm overlay wavelength.

6. The system of claim 5, wherein the insertion wavelength is user selectable.

7. The system of claim of claim 2, wherein a frequency of the QAM signal is user selectable to facilitate the insertion of the QAM signal into an existing RF spectrum that is being transmitted by 1550 nm overlay wavelength of the PON without causing interference to any of the RF signals.

8. The system of claim 2, wherein the optical amplifier comprises an Erbium-doped fiber amplifier (EDFA) or Erbium-Ytterbium doped fiber amplifier (EYDFA).

9. The system of claim 2, wherein the optical amplifier circuit includes a user control that is accessible on an outside of the cabinet for actuating a gain circuit of the optical amplifier.

10. The system of claim 1, wherein the circuit comprising slots is further configured to receive an RF input port for receiving an input signal, an RF output port, RF ports for input and output test points, RF tap ports for the input signal to be directed to the slots, RF tap ports for the input signal to be directed to a cable modem, RF ports for coupling an output of the QAM modulator and the input signal, an attachment point for receiving a QAM channel deletion filter and connecting the QAM channel deletion filter in series between the RF input port and the RF output port.

10. The system of claim 1, wherein the power supply is removable and configured to draw power from both a network and a power utility.

12. A multichannel digital video insertion system for providing a multiplexed output digital video signal, the system comprising:
at least one video encoder module that includes an input connector for receiving a video signal, an encoder circuit for converting the video signal to a QAM signal, and an output connector for communicating the QAM signal;
an optical transmission section with an input configured to receive the QAM signal and an output configured to communicate the QAM signal over an optical cable; and
a cabinet having an area for receiving the video encoder module and the optical transmission section, the area being accessible from outside of the cabinet such that the video encoder module and the optical transmission section are insertable and removable from outside of the cabinet.

13. The system of claim 12, wherein the QAM to optical transmission section comprises an optical transmitter configured to modulate a QAM signal output from the QAM modulator onto an optical signal and to communicate the optical signal over an optical fiber.

14. The system of claim 12, wherein the QAM to optical transmission section comprises at least one optical amplifier circuit that includes a plurality of optical outputs, wherein the at least one optical amplifier circuit is configured to distribute the optical signal from the optical transmitter to the plurality of optical outputs.

15. The system of claim 12, wherein an output signal of the optical amplifier is being modulated by an RF/QAM signal and is configured to be inserted into a passive optical network (PON) that has a 1550 nm video overlay service associated with it.

16. The system of claim 15, wherein the output signal of the optical transmission section is transmitted at an insertion wavelength that does not interfere with existing 1550 nm overlay wavelength.

17. The system of claim 16, wherein the insertion wavelength is user selectable.

18. The system of claim of claim 13, wherein a frequency of the QAM signal is user selectable to facilitate the insertion of the QAM signal into an existing RF spectrum that is being transmitted by 1550 nm overlay wavelength of the PON without causing interference to any of the RF signals.

19. The system of claim 13, wherein the optical amplifier comprises an Erbium-doped fiber amplifier (EDFA) or Erbium-Ytterbium doped fiber amplifier (EYDFA).

20. The system of claim 13, wherein the optical amplifier amplifier includes a user control that is accessible on an outside of the cabinet for actuating a gain circuit of the optical amplifier.

21. The system of claim 13, wherein the circuit comprising slots is further configured to receive an RF input port for receiving an input signal, an RF output port, RF ports for input and output test points, RF tap ports for the input signal to be directed to the slots, RF tap ports for the input signal to be directed to a cable modem, RF ports for coupling an output of the QAM modulator and the input signal, an attachment point for receiving a QAM channel deletion filter and connecting the QAM channel deletion filter in series between the RF input port and the RF output port.

22. The system of claim 12, wherein the power supply is removable and configured to draw power from both a network and a power utility.
